(19) United States
(12) Patent Application Publication
(10) Pub. No.: US 2023/0092545 A1
(43) Pub. Date: Mar. 23, 2023

(54) IMAGE DATA ANALYTICS USING NEURAL NETWORKS FOR AUTOMATED DESIGN EVALUATION

(71) Applicant: Accenture Global Solutions Limited, Dublin (IE)

(72) Inventors: Syama Sundar Santosh Kumar Gopasana, Hyderabad (IN); Richa Sahrawat Malik, Bengaluru (IN); Rakesh Ba Kumar, GURGAON (IN); Ruchi Soni, New Delhi (IN); Aniruddha Ray, Bengaluru (IN)

(21) Appl. No.: 17/482,710

(22) Filed: Sep. 23, 2021

(51) Int. Cl. G06F 30/27; G06N 3/08

(52) U.S. Cl. CPC G06F 30/27; G06N 3/08

(57) ABSTRACT

Implementations are directed to design advisor platform uses machine learning (ML) models (e.g., deep learning models, such as convolutional neural networks (CNNs)) to compare an input design with a set of reference designs and provide evaluation and recommendation of the input design on-the-fly (i.e., in real-time).

### BACKGROUND

Product lifecycles can include multiple processes. Example processes can include, without limitation, a design process, a testing process, and a production process. Each process can include one or more phases. For example, an example design process can include multiple iterations of generating a design, evaluating the design, and changing the design before a final design is decided on. In this process, a set of design features are evaluated, typically, in an effort to achieve an appealing design that has some confidence of success (e.g., commercial success, design awards). This is a resource-intensive and time-consuming process and is subjective to the designer(s) evaluating the design. More plainly stated, design process can be a tedious, iterative process as the designer subjectively seeks to capture an appealing design.

Computer-implemented design tools have been developed in an effort to streamline the design process and reduce the time and cost of design cycles. For example, computer-implemented design tools can assist inventors using image classification technology that can be used to classify designs into one or more classes. For example, in evaluating a design, traditional computer-implemented design tools are limited to assigning class label values to an image, each class label value representing a degree of a respective design feature present in the design. That is, traditional computer-implemented design tools provide a single prediction (class label values) of a design. However, traditional computer-implemented design tools cannot objectively evaluate designs in terms of a set of design features and/or provide recommendations for improving a design based on a set of known designs. That is, traditional computer-implemented design tools cannot summarize designs in terms of multiple features represented within the design and/or provide improvements to designs in terms of one or more of the multiple features.

### SUMMARY

Implementations of the present disclosure are generally directed to computer-implemented systems for assisting in product design phases. More particularly, implementations of the present disclosure are directed to a computer-implemented design advisor platform for assisting in design phases of products. In some implementations, the . . . .

In some implementations, actions include receiving an input design recorded in a computer-readable file, providing an input design feature vector representative of the input design by processing the input design through the machine learning (ML) model, the input design feature vector being extracted from the ML model at a layer preceding a final layer of the ML model, determining a first sub-set of reference designs from a set of reference designs used to train the ML model, the first sub-set of reference designs being determined at least partially by calculating a first set of similarity scores, each similarity score indicating a degree of similarity between the input design feature vector and a reference design feature vector of a respective reference design in the first set of reference designs, identifying at least a first design feature of a set of design features of the input design as a negative design feature at least partially by: determining a set of statistics for each design feature in the set of design features based on label values of reference designs in the first sub-set of reference designs, comparing a statistic of the at least a first design feature to a threshold, and identifying the at least a first design feature as a negative design feature in response to the statistic failing to exceed the threshold, in response to identifying the at least a first design feature vector as a negative design feature, selecting at least one reference design from the set of reference designs as a recommended design at least partially by determining a range for the at least a first design feature based on at least a portion of a set of statistics of the at least a first design feature, and determining that a label value of the at least one reference design is within the range, and in response, selecting the at least one reference design from the set of reference designs as a recommended design, and outputting a recommendation set including the recommended design for subsequent adjustment of the input design in view of the recommended design. Implementations of the present disclosure also include corresponding systems, apparatus, and computer programs, configured to perform the actions of the methods, encoded on computer storage devices.

These and other implementations can each optionally include one or more of the following features: actions further include identifying at least a second design feature of the set of design features of the input design as a positive design feature at least partially by comparing a statistic of the at least a second design feature to the threshold, and identifying the at least a second design feature as a positive design feature in response to the statistic exceeding the threshold; the label value of the at least one reference design includes an adjusted class label value that is adjusted from a class label value during tuning of the ML model to provide a tuned ML model; tuning of the ML model includes retraining at least a portion of the ML model; the range is determined based on a Z-score of the at least a first design feature and a set of statistics of the at least a first design feature calculated from label values of the at least a first design feature over all reference designs in the set of reference designs; actions further include receiving an adjusted input design recorded in a computer-readable file, the adjusted input design comprising one or more modifications to the input design, providing an adjusted input design feature vector representative of the adjusted input design by processing the adjusted input design through the ML model, the adjusted input design feature vector being extracted from the ML model at the layer preceding the final layer of the ML model, determining a second sub-set of reference designs from the set of reference designs used to train the ML model, the second sub-set of reference designs being determined at least partially by calculating a second set of similarity scores, each similarity score indicating a degree of similarity between the adjusted input design feature vector and a reference design feature vector of a respective reference design in the set of reference designs and determining that the adjusted input design is absent a negative design feature; and the ML model includes a convolution neural network (CNN).

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system that can execute implementations of the present disclosure.

FIG. 2 depicts a conceptual architecture including a design advisor platform in accordance with implementations of the present disclosure.

FIG. 3 depicts example class label tuning in accordance with implementations of the present disclosure.

FIG. 4 depicts a representation of a portion of a process for identifying reference designs in accordance with implementations of the present disclosure.

FIG. 5 depicts an example process that can be executed in accordance with implementations of the present disclosure.

Like reference symbols in the various drawings indicate like elements.

### DETAILED DESCRIPTION

Implementations of the present disclosure are generally directed to computer-implemented systems for assisting in product design phases. More particularly, implementations of the present disclosure are directed to a computer-implemented design advisor platform for assisting in design phases of products.

In some implementations, actions include receiving an input design recorded in a computer-readable file, providing an input design feature vector representative of the input design by processing the input design through the machine learning (ML) model, the input design feature vector being extracted from the ML model at a layer preceding a final layer of the ML model, determining a first sub-set of reference designs from a set of reference designs used to train the ML model, the first sub-set of reference designs being determined at least partially by calculating a first set of similarity scores, each similarity score indicating a degree of similarity between the input design feature vector and a reference design feature vector of a respective reference design in the first set of reference designs, identifying at least a first design feature of a set of design features of the input design as a negative design feature at least partially by: determining a set of statistics for each design feature in the set of design features based on label values of reference designs in the first sub-set of reference designs, comparing a statistic of the at least a first design feature to a threshold, and identifying the at least a first design feature as a negative design feature in response to the statistic failing to exceed the threshold, in response to identifying the at least a first design feature vector as a negative design feature vector, selecting at least one reference design from the set of reference designs as a recommended design at least partially by determining a range for the at least a first design feature based on at least a portion of a set of statistics of the at least a first design feature, and determining that a label value of the at least one reference design is within the range, and in response, selecting the at least one reference design from the set of reference designs as a recommended design, and outputting a recommendation set including the recommended design for subsequent adjustment of the input design in view of the recommended design.

To provide context for implementations of the present disclosure, and as introduced above, product lifecycles can include multiple processes. Example processes can include, without limitation, a design process, a testing process, and a production process. Each process can include one or more phases. For example, an example design process can include multiple iterations of generating a design, evaluating the design, and changing the design before a final design is decided on. In this process, a set of design features are evaluated, typically, in an effort to achieve an appealing design that has some confidence of success (e.g., commercial success, design awards). This is a resource-intensive and time-consuming process and is subjective to the designer(s) evaluating the design. More plainly stated, design process can be a tedious, iterative process as the designer subjectively seeks to capture an appealing design.

Computer-implemented design tools have been developed in an effort to streamline the design process and reduce the time and cost of design cycles. For example, computer-implemented design tools can assist inventors using image classification technology that can be used to classify designs into one or more classes. For example, in evaluating a design, traditional computer-implemented design tools are limited to assigning class labels to an image, each class label representing a degree of a respective design feature present in the design. That is, traditional computer-implemented design tools provide a single prediction (class label values) of a design. However, traditional computer-implemented design tools cannot objectively evaluate designs in terms of a set of design features and/or provide recommendations for improving a design based on a set of known designs. That is, traditional computer-implemented design tools cannot summarize designs in terms of multiple features represented within the design and/or provide improvements to designs in terms of one or more of the multiple features.

In view of this, implementations of the present disclosure provide a computer-implemented design advisor platform for assisting in design phases of products. More particularly, and as described in further detail herein, the design advisor platform uses machine learning (ML) models (e.g., deep learning models, such as convolutional neural networks (CNNs)) to compare an input design with a set of reference designs and provide evaluation and recommendation of the input design on-the-fly (i.e., in real-time). In some examples, the ML model is a classifier that typically classifies designs with respect to a set of class labels, each class label represents a design feature. Example design features include, but are not limited to, visual hierarchy, imagery, harmony, and typography. However, and as described in further detail herein, once trained, the ML model is used to provide an input design feature vector for evaluation of the input design. That is, evaluation of the input design is achieved without reference to or need of a set of class labels assigned to the input design by the ML model.

In further detail, the designs in the set of reference designs are used as training data to train the ML model. For example, each reference design is assigned a label value for each class label in the set of class labels. The ML model is trained using training data (i.e., the set of reference designs). The ML model is tuned to probabilistically adjust the class label values of the training data 222 to provide adjusted class label values for each of the reference designs, and the adjusted class label values are stored in a database. In some examples, statistics (e.g., mean, standard deviation) are determined for each adjusted class label across the adjusted class label values of all reference designs.

In accordance with implementations of the present disclosure, after training, each reference design in the set of reference designs (i.e., the training data) is processed by the ML model and a feature vector is extracted for each reference design. In some examples, the feature vector is extracted from a specified layer of the ML model. Each feature vector can be described as a multi-dimensional, numerical representation of a respective reference design. The feature vectors of the reference designs are stored in a database.

An input design is processed by the ML model and a feature vector is extracted for the input design. In some examples, the feature vector is extracted from the specified layer of the ML model. The feature vector can be described as a multi-dimensional, numerical representation of the input design and has the same dimension as the feature vectors of the reference designs. The feature vector (representing the input design) is compared to each feature vector of the set of reference designs. For example, the feature vector of the input design and each feature vector of the reference designs are compared using a vector similarity function (e.g., cosine similarity) and a set of similarity scores is provided. Each similarity score represents a degree of similarity between the input design and a respective reference design. The similarity scores are processed to identify the reference designs that are determined to be most similar to the input design. In this manner, a sub-set of reference designs is provided, each reference design in the sub-set of reference designs being considered a representative sample of the input design.

Further, for the reference designs in the sub-set of reference designs, the adjusted class label values are retrieved and statistics (e.g., mean, standard deviation) are determined for the class labels. In some examples, the input design is determined to be good on design features having mean label values that exceed a threshold label value. For design features that do not have mean label values that exceed the threshold label value, Z-scores are determined for each class label value of the reference designs in the sub-set of reference designs against the class label value statistics (e.g., mean, standard deviation) of the reference designs in the set of reference designs (i.e., the full training set). In some examples, reference designs in the set of reference designs having class label values in a specified range are included in a set of recommended designs. The set of recommended designs are provided as output.

Accordingly, and as described in further detail below, the computer-implemented design advisor platform of the present disclosure does not directly assign class label values to the input design. Instead, adjusted class label values of the reference designs in the sub-set of reference designs are used to evaluate the input design in terms of design features. Further, the computer-implemented design advisor platform of the present disclosure does not provide recommended designs based on class label values of the input design. Instead, adjusted class label values of the sub-set of reference designs and of the set of reference designs are used to provide recommended designs. In this manner, the computer-implemented design advisor platform of the present disclosure is able to summarize designs in terms of multiple design features represented within the design and provide improvements to designs in terms of one or more of the multiple features, functionality that is lacking in traditional computer-implemented design tools.

Implementations of the present disclosure are described in further detail herein with reference to designs represented as images recorded in computer-readable files. It is contemplated, however, that implementations of the present disclosure can be realized with any appropriate designs including, but not limited to, multi-dimensional designs represented as multi-dimensional models (e.g., mesh model, point cloud) recorded in computer-readable files.

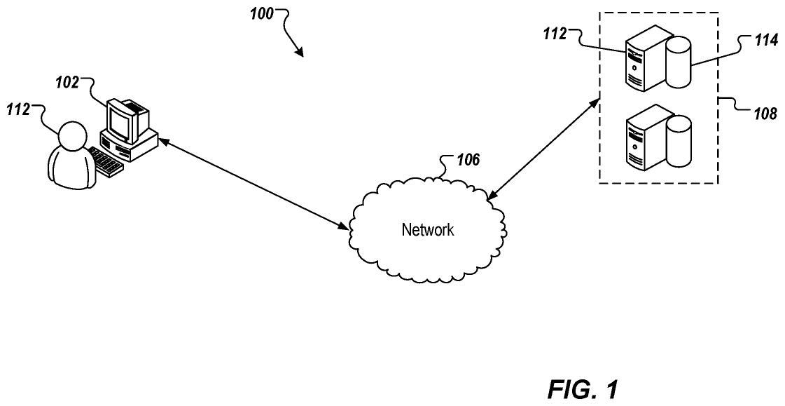

FIG. 1 depicts an example system 100 that can execute implementations of the present disclosure. The example system 100 includes a computing device 102, a back-end system 108, and a network 106. In some examples, the network 106 includes a local area network (LAN), wide area network (WAN), the Internet, or a combination thereof, and connects web sites, devices (e.g., the computing device 102), and back-end systems (e.g., the back-end system 108). In some examples, the network 106 can be accessed over a wired and/or a wireless communications link.

In some examples, the computing device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In the depicted example, the back-end system 108 includes at least one server system 112, and data store 114 (e.g., database and knowledge graph structure). In some examples, the at least one server system 112 hosts one or more computer-implemented services that users can interact with using computing devices. For example, the server system 112 can host one or more applications that are provided as part of an intelligent design platform in accordance with implementations of the present disclosure.

In some examples, the back-end system 108 hosts a design advisor platform in accordance with implementations of the present disclosure. As described in further detail herein, the design advisor platform of the present disclosure receives a design as input (referred to herein as input design) and processes the input design against a set of reference designs to identify one or more design features that the input design is determined to be good on, referred to as positive design features, and one or more design features that the input design is determined not to be good on, referred to as negative design features. In some examples, and as described in further detail herein, an input design is determined to be good on a design feature, if a statistical value associated with the design feature exceeds a threshold statistical value. For negative design features, a set of recommended designs are provided, each recommended design in the set of recommended designs being good on the design feature(s).

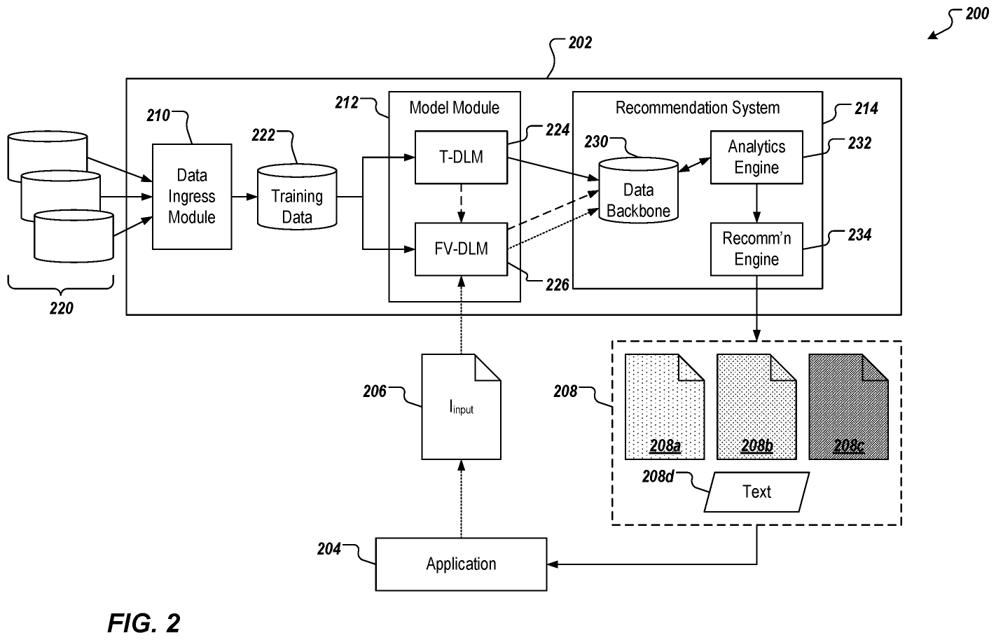

FIG. 2 depicts a conceptual architecture of a system 200 including a design advisor platform 202 in accordance with implementations of the present disclosure. In the example of FIG. 2, an application 204 is in communication with the design advisor platform 202 to submit an input design 206 to the design advisor platform 202. In some examples, the input design 206 is an image that is digitally recorded as a computer-readable file. For example, the application 204 can include a design application that enables users (e.g., the user 112 of FIG. 1) to generate designs in a digital environment and export the designs as computer-readable files, such as image files. The user can submit a design to the design advisor platform 202 as the input design 206.

As described in further detail herein, the design advisor platform 202 processes the input design 206 to provide a recommendation set 208. In some examples, the recommendation set 208 includes a set of recommended designs 208a, 208b, 208c and text 208d (e.g., provided individually or collectively as one or more computer-readable files). In some examples, the text 208d provides a natural-language description of one or more positive design features, and/or one or more design negative features. Example design features include, without limitation, visual hierarchy, imagery, harmony, and typography. In some examples, the set of recommended designs 208a, 208b, 208c are references that are representative of designs that can be referred to for improving the input design 206 in terms of one or more design features. For example, example text 208d can include “Your design is good on harmony and imagery. However, the design needs improvement on typography. References to achieve this are:” and the set of recommended designs 208a, 208b, 208c can be displayed with the text (e.g., in a user interface (UI) of the application 204).

In further detail, in the example of FIG. 2, the design advisor platform 202 includes a data ingress module 210, a model module 212, and a recommendation system 214. The data ingress module 210 ingests reference designs from one or more data sources 220 and processes the known designs to provide training data 222. In some examples, ingestion of reference designs can include ingestion from one or more data lakes and/or real-time ingestion (e.g., as a reference design is stored in a data source 220). For example, a messaging framework (e.g., Kafka) can be used to provide real-time streaming of reference designs to the data ingress module 210. In some examples, one or more change data capture (CDC) tools can be used and are responsive to changes in reference designs (e.g., the addition of a reference design to a data source 220) to trigger ingestion of reference designs through the data ingress module 210.

In some examples, the reference designs include designs that have a known level of success and/or are otherwise determined to be satisfactory designs in achieving some aim. In some examples, success can be defined subjectively (e.g., a particular designer or group of designers approve of the design). In some examples, success can be defined quantitatively (e.g., the design resulted in a threshold number of clicks and/or conversions in an e-commerce setting).

In some examples, the training data 222 is provided by assigning class label values to each class label in a set of class labels. As described herein, each class label represents a respective design feature (e.g., visual hierarchy, imagery, harmony, and typography). Each class label value represents a degree of a respective design feature present in the reference design (e.g., the higher the value, the more the design feature is represented in the reference design). In some examples, the class label values are assigned to the reference designs by one or more experts (e.g., design experts).

The model module 212 includes a tuned deep learning model (T-DLM) 224 and a feature vector DLM (FV-DLM) 226. The recommendation system 214 includes a data backbone 230, an analytics engine 232, and a recommendation engine 234. In some examples, the model module 212 is provided using one or more libraries (e.g., TensorFlow) and one or more data processing frameworks (e.g., Apache Spark). In some examples, the data backbone 230 is provided as a high-speed ingestion and query platform (e.g., SingleStore) that enables real-time model scoring on both streaming and historical data.

In some examples, the DLMs (i.e., the T-DLM 224 and the FV-DLM 226) are each provided as a CNN that processes input data to generate feature vectors (FVs), each feature vector being a multi-dimensional, numerical representation of a respective input data. In some examples, the CNN is a classifier that includes multiple layers culminating in a final layer (e.g., a sigmoid layer) that outputs a set of class label predictions, each class label prediction representing a likelihood that the input data belongs to a respective class. More generally, the CNN can include a feature learning portion and a classification portion. In some examples, the feature learning portion includes multiple convolution (+rectified linear unit (ReLU)) layers with respective pooling layers, and the classification portion includes a flattening layer, a fully connected layer, and a classification layer (e.g., sigmoid)). An example CNN includes, without limitation, ResNet, which is described in detail in Deep Residual Learning for Image Recognition, He et al., Dec. 10, 2015, which is expressly incorporated herein by reference. In accordance with implementations of the present disclosure, the feature vector of an input data is extracted from the CNN before the final layer. For example, the feature vector is extracted immediately before a fully connected layer, which precedes the final layer. Accordingly, and as described in further detail herein, the feature vector is used in evaluating the input data instead of any label values of class labels that would otherwise be output from the final layer.

As described in further detail herein, the T-DLM 224 is a tuned version of the FV-DLM 226. For example, the FV-DLM 226 is trained using the training data 222. In some examples, the (trained) FV-DLM 226 is copied and is tuned to provide the T-DLM 224. In general, tuning is performed to improve an accuracy of the underlying ML model.

In some examples, the FV-DLM 226 (e.g., CNN) is iteratively trained, where, during an iteration, one or more parameters of the FV-DLM 226 are adjusted, and an output is generated based on the training data. For each iteration, a loss value is determined based on a loss function. The loss value represents a degree of accuracy of the output of the FV-DLM 266. The loss value can be described as a representation of a degree of difference between the output of the FV-DLM 226 and an expected output of the FV-DLM 226 (the expected output being provided from the training data). In some examples, if the loss value does not meet an expected value (e.g., is not equal to zero), parameters of the FV-DLM 226 are adjusted in another iteration of training. In some instances, this process is repeated until the loss value meets the expected value (e.g., for each sample of the training data).

In some examples, tuning of the FV-DLM 226 to provide the T-DLM 224 includes copying the (trained) FV-DLM 226 as an initial T-DLM 224. At least part of the classification portion of the T-DLM 224 is removed. For example, the classification portion as a whole can be removed, or one or more layers (e.g., the fully connected layer, the classification layer) of the classification portion can be removed. At this point, the feature learning portion remains and the parameters (weights) of the layers of the feature learning portion learned during training of the FV-DLM 226 are frozen. That is, for at least a portion of the turning process, the parameters (weights) of the layers of the feature learning portion are static. A new classification portion is added to the T-DLM 224 and is initialized (i.e., initial parameters for one or more layers of the new classification portion are provided). The iterative training process is performed to tune the T-DLM 224, which includes adjusting parameters of the new classification portion. In this manner, the T-DLM 224 is a tuned version of the FV-DLM 226.

After the T-DLM 224 is trained, each reference design is processed through the T-DLM 224 to provide a set of adjusted class label values for each class label. For example, a reference design is input to the T-DLM 224, which predicts a set of adjusted class label values for the reference design. In some examples, one or more of the class label values in the set of adjusted class label values differs from the set of class label values used to train the FV-DLM 226. For example, a reference image can have a set of class label values assigned by a human expert (e.g., as discussed above). The reference image and the set of class label values are used to train the FV-DLM 226 and to tune the T-DLM 224. The reference image is processed through the T-DLM 224, which outputs a set of adjusted class label values (i.e., class label values predicted for the reference image). In some examples, one or more class label values in the set of adjusted class label values differs from respective class label values in the set of class label values (i.e., the set of class label values originally provided for the reference image). In some examples, one or more class label values in the set of adjusted class label values is the same as respective class label values in the set of class label values (i.e., the set of class label values originally provided for the reference image). By adjusting the set of class label values to provide the set of adjusted class label values, any biases that might be inherent in the training data 222 are mitigated (e.g., biases of human experts that provided the original label values).

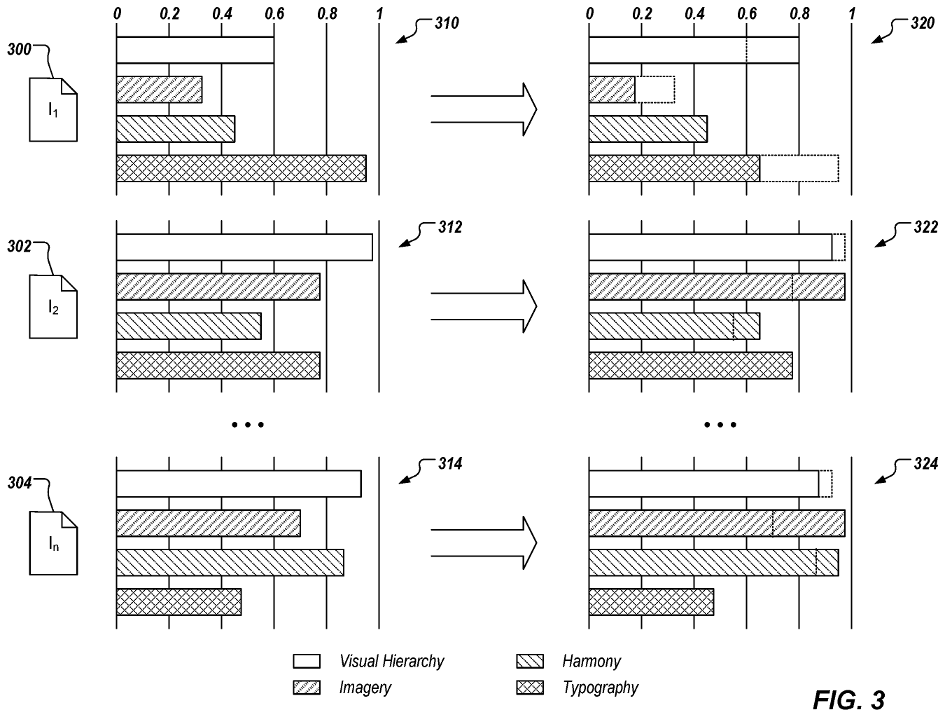

FIG. 3 depicts example class label tuning in accordance with implementations of the present disclosure. In the example of FIG. 3, a set of training data (e.g., the training data 222 of FIG. 2) includes reference designs 300, 302, 304 associated with respective sets of class label values 310, 312, 314. In some examples, each class label value represents a degree of quality of a respective design feature as represented in the respective reference design 300, 302, 304 (e.g., the higher the value, the better quality of the design feature as represented in the reference design). As described herein, the sets of class label values 310, 312, 314 are probabilistically adjusted during the tuning process to provide respective sets of adjusted class label values 320, 322, 324. The adjusted class label values provide a better representation of design features represented in the respective reference designs in view of the complete training data 222 rather than individual, expert-assigned label values.

Accordingly, and as depicted in FIG. 3, sets of adjusted class label probabilities are provided (e.g., {C₁, . . . Cₙ}, where n is the number of reference designs in the training data 222). In some examples, each set of adjusted class label values includes an adjusted label value for each design feature (i.e., class label) (e.g., Cᵢ={c_{i,1}, c_{i,2}, c_{i,3}, c_{i,4}}, where c_{i,1} is a value for visual hierarchy, c_{i,2} is a value for imagery, c_{i,3} is a value for harmony, and c_{i,4} is a value for typography. In some examples, each set of adjusted class label values is associated with a respective identifier that uniquely identifies a respective reference design (ID_{RefD}). In this manner, it can be determined, which reference design corresponds to each set of adjusted class label values.

In some examples, a set of statistics is determined for each design feature across all sets of adjusted class label values. For example, for each design feature across all of the sets of adjusted class label values (CL), a mean (μ) and a standard deviation (σ) are determined. In this manner, a set of overall statistics is provided (e.g., ST_{CL}={[μ₁, σ₁]_{CL}, [μ₂, σ₂]_{CL}, [μ₃, σ₃]_{CL}, [μ₄, σ₄]_{CL}}, where 1 indicates visual hierarchy, 2 indicates imagery, 3 indicates harmony, and 4 indicates typography). Accordingly, the set of overall statistics is provided based on the adjusted class label values provided after tuning (e.g., righthand side of FIG. 3).

In accordance with implementations of the present disclosure, after the FV-DLM 226 is trained, each reference design in the training data 222 is processed through the FV-DLM 226 and a feature vector is extracted and is stored in the data backbone 230. In this manner, a set of reference design feature vectors is provided (e.g., {f_{RefD1}, . . . , f_{RefDn}}, where n is the number of reference designs in the training data 222). For example, each reference design feature vector is extracted from the FV-DLM 226 before the final layer (e.g., immediately before a fully connected layer, which precedes the final layer). In some examples, each reference design feature vector is associated with a respective ID_{RefD}. In this manner, it can be determined, which reference design corresponds to which reference design feature vector.

The input design 206 is processed by the FV-DML 226 and a feature vector (f_{lnpD}) is extracted for the input design 206. In some examples, the feature vector is extracted from the FV-DLM 226 before the final layer (e.g., immediately before a fully connected layer, which precedes the final layer). The feature vector of the input design is stored in the data backbone 222. In some examples, the input design feature vector is associated with an input design identifier (ID_{lnpD}).

The analytics engine 232 retrieves the feature vector of the input design and the set of reference design feature vectors from the data backbone 222 and compares the input design feature vector to each reference design feature vector in the set of reference design feature vectors. For example, the input design feature vector and each reference design feature vector are compared using a vector similarity function (e.g., cosine similarity) and a set of similarity scores (S) is provided. Each similarity score represents a degree of similarity between the input design feature vector and a respective reference design feature vector (and thus, between the input design and a respective reference design).

In further detail, the cosine similarity can be described as a measurement that quantifies the similarity between vectors and is bound by a constrained range of 0 and 1. The cosine similarity is calculated as the cosine of the angle between the vectors, where the vectors are typically non-zero and are within an inner product space. The cosine similarity can be mathematically described as the division between the dot product of the vectors and the product of the Euclidean norms of the vectors. For example, if the angle between vectors is 90°, the cosine similarity will have a value of 0, which means that the vectors are orthogonal (perpendicular) to each other. As the cosine similarity measurement gets closer to 1, the angle between the vectors is smaller. The smaller the angle between the vectors, the more similar that the vectors are. For example, a cosine similarity of 1 indicates that the vectors are identical.

The analytics engine 232 processes the similarity scores to identify the reference designs that are determined to be most similar to the input design 206. In this manner, a sub-set of reference designs is provided, each reference design in the sub-set of reference designs being considered a representative sample of the input design 206.

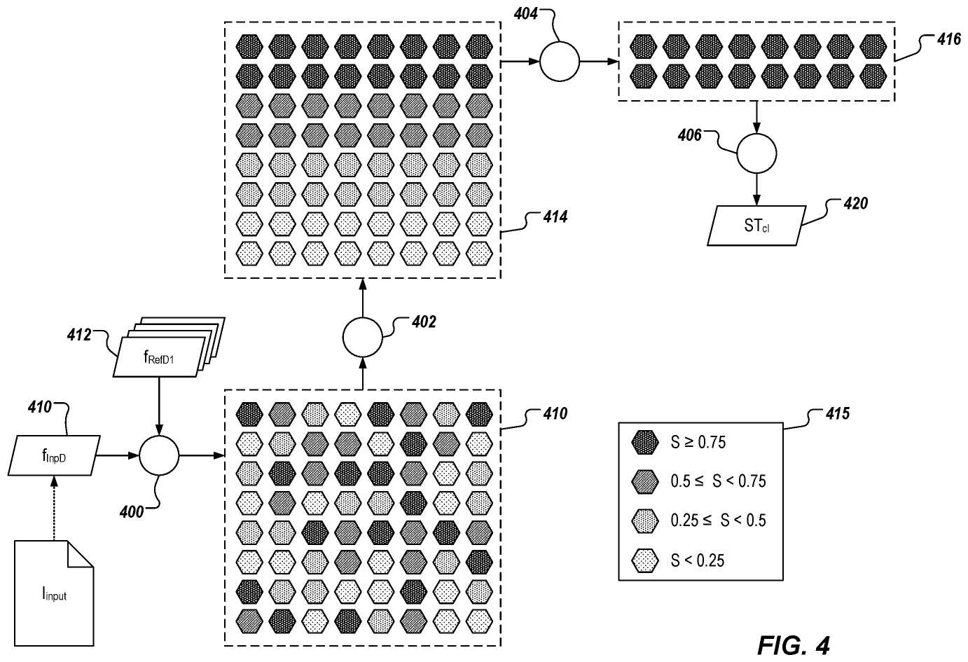

FIG. 4 depicts a representation of a portion of a process for identifying reference designs in accordance with implementations of the present disclosure. In some examples, the portion of the process of FIG. 4 is executed by the analytics engine 232.

In the example of FIG. 4, a similarity function 400, a sorting function 402, a sub-set selection function 404, and a statistics function 406 are provided. The similarity function 400 processes an input design feature vector 410 and a set of reference design feature vectors 412 to provide a set of similarity scores (S) 410. Each similarity score in the set of similarity scores 410 represents a degree of similarity between the input design feature vector and a respective reference design feature vector. In some examples, the sorting function 402 sorts the set of similarity scores 410 based on values of the similarity scores to provide a sorted set of similarity scores 414. For example, the similarity scores can be sorted into quarters based on ranges of similarity scores 415. The sub-set selection function 404 selects a sub-set of similarity scores 410 from the sorted set of similarity scores 414. For example, the sub-set selection function 404 selects the top quarter of similarity scores as the sub-set of similarity scores 416.

In some examples, a sub-set of reference designs is determined based on the sub-set of similarity scores 416. For example, the sub-set of reference designs includes reference designs represented in the sub-set of similarity scores 416. In some examples, for each similarity score in the sub-set of similarity scores, the respective ID_{RefD} is included in the sub-set of reference designs. In some examples, the set of adjusted class label values of each reference design in the sub-set of reference designs is retrieved (e.g., by the analytics engine 232 from the data backbone 230). For example, for each reference design in the sub-set of reference designs the respective ID_{RefD} is used to retrieve the respective set of adjusted class label values to include in a sub-set of sets of adjusted class label values (cl). The sub-set of sets of adjusted class label values (cl) includes fewer sets of adjusted class label values than all of the sets of adjusted class label values (CL).

In some examples, the statistics function 406 processes the sub-set of sets of adjusted class label values (cl) to provide sub-set statistics 420 for each design feature across the sub-set of sets of adjusted class label values. For example, for each design feature across the sub-sets of sets of adjusted class label values (cl), a mean (μ) and a standard deviation (σ) are determined. In this manner, the sub-set statistics 420 is provided (e.g., ST_{cl}={[μ₁, σ₁]_{cl}, [μ₂, σ₂]_{cl}, [μ₃, σ₃]_{cl}, [μ₄, σ₄]_{cl}}, where 1 indicates visual hierarchy, 2 indicates imagery, 3 indicates harmony, and 4 indicates typography). Accordingly, the sub-set statistics is provided based on the adjusted class label values provided after tuning (e.g., righthand side of FIG. 3).

In accordance with implementations of the present disclosure, the sub-set statistics (ST_{cl}) and the set of overall statistics (ST_{CL}) are processed to determined which design feature(s) the input design 206 is good on (positive design feature(s)), and which design feature(s) the input design 206 is not good on (negative design feature(s)). For example, the recommendation engine 234 processes the sub-set statistics (ST_{cl}) and the set of overall statistics (ST_{CL}) are processed to determined which design feature(s) the input design 206 is good on, and which design feature(s) the input design 206 is not good on.

In further detail, the input design 206 is determined to be good on design features having mean label values that exceed a threshold label value (ϑ) (e.g., ϑ=0.7). For example, each of μ₁, μ₂, μ₃, and μ₄ of ST_{cl} is compared to 9. If a mean label value exceeds ϑ, the input design 206 is determined to be good on the respective design feature. Hence, in terms of the input design 206, the design feature is a positive design feature. For example, and without limitation, it can be determined that μ₂ and μ₃ each exceed ϑ. Consequently, it is mathematically determined that the input design 206 is good on the design features of imagery and harmony, respectively. Hence, imagery and harmony are considered positive design features. Conceptually, it is determined that the input design 206 expresses imagery and harmony that are consistent with reference designs determined to be successful.

For design features that do not have mean label values that exceed the threshold label value, it is determined that the input design 206 is not good on the respective design features. For example, and without limitation, it can be determined that neither μ₁ nor μ₄ exceeds ϑ. Consequently, it is mathematically determined that the input design 206 is not good on the design features of visual hierarchy and typography, respectively. Hence, in terms of the input design 206, visual hierarchy and typography are considered negative design features. In response to determining that the input design 206 is not good on at least one design feature, one or more recommended designs are identified from the set of reference designs, each recommended design being good on the at least one design feature.

In further detail, for each negative design feature identified for the input design 206, a Z-score is determined based on the class label value of the reference designs in the sub-set of reference designs against the class label value statistics (e.g., mean, standard deviation) of the reference designs in the set of reference designs (i.e., the full training set). The Z-score, also referred to as the standard score, can be described as the number of standard deviations that a value of a raw score (x) is above or below the mean value of what is being measured. In the context of the present disclosure, the raw score (x) is the mean value of the class label value determined for the sub-set of reference designs. An example relationship for calculating the Z-score of a respective design feature can be provided as:

$${z}_{i} = \frac{{μ}_{i , cl} - {μ}_{i , CL}}{{σ}_{i , CL}}$$

where zᵢ is the Z-score for the i^{th} design feature, μ_{i,cl} is the mean class label value for the i^{th} design feature across reference designs in the sub-set of reference designs, μ_{i,CL} is the mean class label value for the i^{th} design feature across all reference designs in the set of reference designs (i.e., the entire training data), and σ_{i,CL} is the class label value standard deviation for the it design feature across all reference designs in the set of reference designs (i.e., the entire training data).

For each for each negative design feature, a range (R) is calculated based on the statistical values. The range can be provided as:

Rᵢ=[ϑ,max{(ϑ+zᵢμᵢ),1}]

where Rᵢ is the range for the i^{th} design feature. For each negative design feature, adjusted class label values of each reference design in the set of reference designs is compared to the respective range and, if the adjusted class label value of a reference design is within the respective range, the reference design is included in a set of recommended designs. In some examples, in instances where the input design 206 has multiple negative design features, a reference design is only included in the set of recommended designs, if each of the adjusted class label value is within the respective design range. Instead of simply defining the range as [ϑ, 1], implementations of the present disclosure are able to provide recommended designs that are more productive in steering subsequent adjustments to the input design. More specifically, if the mean of a design feature is too low, providing a recommended design having a high mean (e.g., 1) is disadvantageous for directing improvements to the input design. That is, if a poor input design is provided, a masterpiece design provided as a recommended design will not be helpful, as there is too much of a disparity between the input design and the recommended design.

As described above with reference to FIG. 2, the recommendation set 208 is output from the recommendation engine 234. For example, the recommendation engine 234 outputs the recommendation set 208 to the application 204, which visually displays the recommendation set 208. In some examples, the set of recommended designs 208a, 208b, 208c include reference designs that, for a negative design feature of the input design 206, has a class label probability within the respective range determined for the negative design feature. In some examples, each recommended design 208a, 208b, 208c is displayed as an image of the respective design. In some examples, the text 208d identifies the positive design feature(s) and the negative design feature(s) of the input design 206. In some examples, the text 208d indicates that the recommended designs 208a, 208b, 208c are examples that can be referenced for improving the negative design feature(s).

In accordance with implementations of the present disclosure, an iterative design process is performed to adjust the input design to a point that it is absent negative design features. For example, the input design 206 can be adjusted in view of the recommended designs 208a, 208b, 208c. Continuing with the example above, the input design 206 can be adjusted to adjust visual hierarchy and typography of the input design 206. In this manner, an adjusted input design can be provided. The adjusted input design is processed through the design advisor platform 202, as described herein with respect to the input design 206, to identify any positive design features and any negative design features and, again provide a set of recommendations, if any negative design feature is identified. In some examples, iterations can be executed until no negative design features are identified.

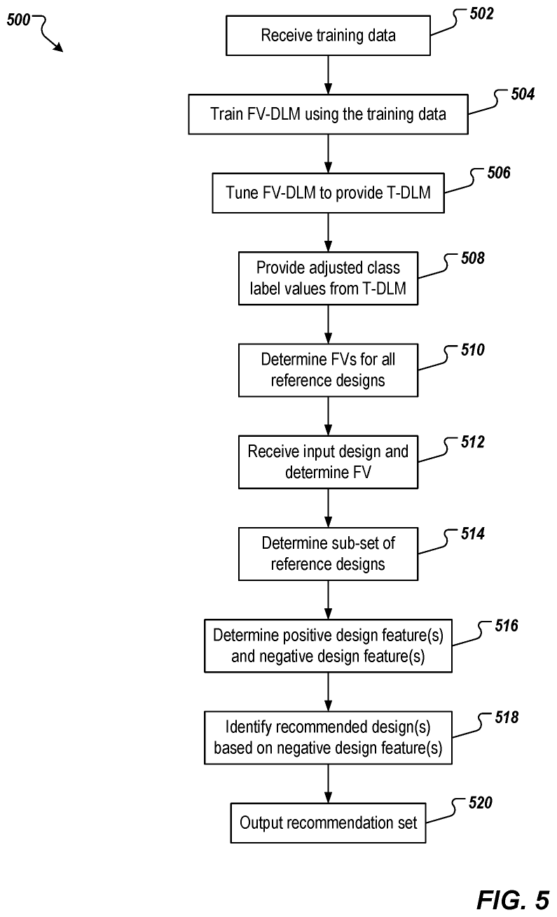

FIG. 5 depicts an example process 500 that can be executed in accordance with implementations of the present disclosure. In some implementations, the example process 500 may be performed using one or more computer-executable programs executed using one or more computing devices.

Training data is received (502). For example, and as described herein with reference to FIG. 2, the data ingress module 210 ingests reference designs from one or more data sources 220 and processes the known designs to provide training data 222. In some examples, the training data 222 includes a set of reference designs and, for each reference design a set of class label values, each class label value indicating a degree, to which the respective reference design reflects a respective design feature. A FV-DLM is trained using the training data (504). For example, and as described herein, an iterative training process is executed to train the FV-DLM using the training data 222.

The FV-DLM is tuned to provide a T-DLM (506). For example, and as described herein, at least part of the classification portion of the T-DLM 224 is removed, such that the feature learning portion remains and the parameters (weights) of the layers of the feature learning portion learned during training of the FV-DLM 226 are frozen. A new classification portion is added to the T-DLM 224 and is initialized, and the iterative training process is performed to tune the T-DLM 224, which includes adjusting parameters of the new classification portion. Adjusted class label values are determined from tuning the T-DLM (508). For example, and as described herein with reference to FIG. 3, the sets of class label values 310, 312, 314 are probabilistically adjusted during tuning to provide the sets of adjusted class label values 320, 322, 324. For example, a reference design is input to the T-DLM 224, which predicts a set of adjusted class label values for the reference design.

Feature vectors are determined for each reference design in the set of reference designs (510). For example, and as described herein, after the FV-DLM 226 is trained, each reference design in the training data 222 is processed through the FV-DLM 226 and a feature vector is extracted and is stored in the data backbone 230. In this manner, a set of reference design feature vectors is provided (e.g., {f_{RefD1}, . . . , f_{RefDn}}, where n is the number of reference designs in the training data 222). For example, each reference design feature vector is extracted from the FV-DLM 226 before the final layer (e.g., immediately before a fully connected layer, which precedes the final layer). An input design is received and a feature vector is determined for the input design (512). For example, and as described herein, the input design 206 is processed by the FV-DML 226 and a feature vector (f_{lnpD}) is extracted for the input design 206. In some examples, the feature vector is extracted from the FV-DLM 226 before the final layer (e.g., immediately before a fully connected layer, which precedes the final layer).

A sub-set of reference designs is determined (514). For example, and as described herein with reference to FIG. 4, the similarity function 400 processes an input design feature vector 410 and a set of reference design feature vectors 412 to provide a set of similarity scores (S) 410. Each similarity score in the set of similarity scores 410 represents a degree of similarity between the input design feature vector and a respective reference design feature vector. In some examples, the sorting function 402 sorts the set of similarity scores 410 based on values of the similarity scores to provide a sorted set of similarity scores 414. For example, the similarity scores can be sorted into quarters based on ranges of similarity scores 415. The sub-set selection function 404 selects a sub-set of similarity scores 410 from the sorted set of similarity scores 414. For example, the sub-set selection function 404 selects the top quarter of similarity scores as the sub-set of similarity scores 416. In some examples, a sub-set of reference designs is determined based on the sub-set of similarity scores 416. For example, the sub-set of reference designs includes reference designs represented in the sub-set of similarity scores 416. In some examples, for each similarity score in the sub-set of similarity scores, the respective ID_{RefD} is included in the sub-set of reference designs.

Positive design feature(s) and negative design feature(s) are determined for the input design (516). For example, and as described herein, a design feature of the input design 206 is determined to be a positive design feature if a respective mean label value exceeds a threshold label value (ϑ) (e.g., ϑ=0.7). If a mean label value exceeds B, the input design 206 is determined to be good on the respective design feature. Hence, in terms of the input design 206, the design feature is a positive design feature. Further, a design feature of the input design 206 is determined to be a negative design feature if a respective mean label value does not exceed a threshold label value (ϑ).

A set of recommended designs is identified based on negative design feature(s) (518). For example, and as described herein, for each negative design feature identified for the input design 206, a Z-score is determined based on the class label value of the reference designs in the sub-set of reference designs against the class label value statistics (e.g., mean, standard deviation) of the reference designs in the set of reference designs (i.e., the full training set). For each for each negative design feature, a range (R) is calculated based on the statistical values, and adjusted class label values of each reference design in the set of reference designs is compared to the respective range. If the adjusted class label value of a reference design is within the respective range, the reference design is included in a set of recommended designs.

A recommendation set is output (520). For example, and as described herein, the recommendation engine 234 outputs the recommendation set 208 to the application 204, which visually displays the recommendation set 208. In some examples, the set of recommended designs 208a, 208b, 208c include reference designs that, for a negative design feature of the input design 206, has a class label probability within the respective range determined for the negative design feature. In some examples, each recommended design 208a, 208b, 208c is displayed as an image of the respective design. In some examples, the text 208d identifies the positive design feature(s) and the negative design feature(s) of the input design 206. In some examples, the text 208d indicates that the recommended designs 208a, 208b, 208c are examples that can be referenced for improving the negative design feature(s).

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code) that constitutes processor firmware, a protocol stack, a database management system, an operating system, or a combination of one or more of them. A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display), LED (light-emitting diode) monitor, for displaying information to the user and a keyboard and a pointing device (e.g., a mouse or a trackball), by which the user may provide input to the computer. Other kinds of devices may be used to provide for interaction with a user as well; for example, feedback provided to the user may be any appropriate form of sensory feedback (e.g., visual feedback, auditory feedback, or tactile feedback); and input from the user may be received in any appropriate form, including acoustic, speech, or tactile input.

Implementations may be realized in a computing system that includes a back-end component (e.g., as a data server), or that includes a middleware component (e.g., an application server), or that includes a front end component (e.g., a client computer having a graphical user interface or a Web browser through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”) (e.g., the Internet).

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the to be filed claims.

What is claimed is:

1. A computer-implemented method for iteratively adjusting a data responsive to objective evaluation of the data using a machine learning (ML) model, the method comprising:
receiving an input design recorded in a computer-readable file;
providing an input design feature vector representative of the input design by processing the input design through the ML model, the input design feature vector being extracted from the ML model at a layer preceding a final layer of the ML model;
determining a first sub-set of reference designs from a set of reference designs used to train the ML model, the first sub-set of reference designs being determined at least partially by calculating a first set of similarity scores, each similarity score indicating a degree of similarity between the input design feature vector and a reference design feature vector of a respective reference design in the first set of reference designs;
identifying at least a first design feature of a set of design features of the input design as a negative design feature at least partially by:
determining a set of statistics for each design feature in the set of design features based on label values of reference designs in the first sub-set of reference designs,
comparing a statistic of the at least a first design feature to a threshold, and
identifying the at least a first design feature as a negative design feature in response to the statistic failing to exceed the threshold;
in response to identifying the at least a first design feature vector as a negative design feature, selecting at least one reference design from the set of reference designs as a recommended design at least partially by:
determining a range for the at least a first design feature based on at least a portion of a set of statistics of the at least a first design feature, and
determining that a label value of the at least one reference design is within the range, and in response, selecting the at least one reference design from the set of reference designs as a recommended design; and
outputting a recommendation set comprising the recommended design for subsequent adjustment of the input design in view of the recommended design.

2. The method of claim 1, further comprising identifying at least a second design feature of the set of design features of the input design as a positive design feature at least partially by:
comparing a statistic of the at least a second design feature to the threshold, and
identifying the at least a second design feature as a positive design feature in response to the statistic exceeding the threshold.

3. The method of claim 1, wherein the label value of the at least one reference design comprises an adjusted class label value that is adjusted from a class label value during tuning of the ML model to provide a tuned ML model.

4. The method of claim 2, wherein tuning of the ML model comprises retraining at least a portion of the ML model.

5. The method of claim 1, wherein the range is determined based on a Z-score of the at least a first design feature and a set of statistics of the at least a first design feature calculated from label values of the at least a first design feature over all reference designs in the set of reference designs.

6. The method of claim 1, further comprising:
receiving an adjusted input design recorded in a computer-readable file, the adjusted input design comprising one or more modifications to the input design;
providing an adjusted input design feature vector representative of the adjusted input design by processing the adjusted input design through the ML model, the adjusted input design feature vector being extracted from the ML model at the layer preceding the final layer of the ML model;
determining a second sub-set of reference designs from the set of reference designs used to train the ML model, the second sub-set of reference designs being determined at least partially by calculating a second set of similarity scores, each similarity score indicating a degree of similarity between the adjusted input design feature vector and a reference design feature vector of a respective reference design in the set of reference designs; and
determining that the adjusted input design is absent a negative design feature.

7. The method of claim 1, wherein the ML model comprises a convolution neural network (CNN).

8. One or more non-transitory computer-readable storage media coupled to one or more processors and having instructions stored thereon which, when executed by the one or more processors, cause the one or more processors to perform operations for iteratively adjusting a data responsive to objective evaluation of the data using a machine learning (ML) model, the operations comprising:
receiving an input design recorded in a computer-readable file;
providing an input design feature vector representative of the input design by processing the input design through the ML model, the input design feature vector being extracted from the ML model at a layer preceding a final layer of the ML model;
determining a first sub-set of reference designs from a set of reference designs used to train the ML model, the first sub-set of reference designs being determined at least partially by calculating a first set of similarity scores, each similarity score indicating a degree of similarity between the input design feature vector and a reference design feature vector of a respective reference design in the first set of reference designs;
identifying at least a first design feature of a set of design features of the input design as a negative design feature at least partially by:
determining a set of statistics for each design feature in the set of design features based on label values of reference designs in the first sub-set of reference designs,
comparing a statistic of the at least a first design feature to a threshold, and
identifying the at least a first design feature as a negative design feature in response to the statistic failing to exceed the threshold;
in response to identifying the at least a first design feature vector as a negative design feature, selecting at least one reference design from the set of reference designs as a recommended design at least partially by:
determining a range for the at least a first design feature based on at least a portion of a set of statistics of the at least a first design feature, and
determining that a label value of the at least one reference design is within the range, and in response, selecting the at least one reference design from the set of reference designs as a recommended design; and
outputting a recommendation set comprising the recommended design for subsequent adjustment of the input design in view of the recommended design.

9. The non-transitory computer-readable storage media of claim 8, wherein operations further comprise identifying at least a second design feature of the set of design features of the input design as a positive design feature at least partially by:
comparing a statistic of the at least a second design feature to the threshold, and
identifying the at least a second design feature as a positive design feature in response to the statistic exceeding the threshold.

10. The non-transitory computer-readable storage media of claim 8, wherein the label value of the at least one reference design comprises an adjusted class label value that is adjusted from a class label value during tuning of the ML model to provide a tuned ML model.

11. The non-transitory computer-readable storage media of claim 10, wherein tuning of the ML model comprises retraining at least a portion of the ML model.

12. The non-transitory computer-readable storage media of claim 8, wherein the range is determined based on a Z-score of the at least a first design feature and a set of statistics of the at least a first design feature calculated from label values of the at least a first design feature over all reference designs in the set of reference designs.

13. The non-transitory computer-readable storage media of claim 8, wherein operations further comprise:
receiving an adjusted input design recorded in a computer-readable file, the adjusted input design comprising one or more modifications to the input design;
providing an adjusted input design feature vector representative of the adjusted input design by processing the adjusted input design through the ML model, the adjusted input design feature vector being extracted from the ML model at the layer preceding the final layer of the ML model;
determining a second sub-set of reference designs from the set of reference designs used to train the ML model, the second sub-set of reference designs being determined at least partially by calculating a second set of similarity scores, each similarity score indicating a degree of similarity between the adjusted input design feature vector and a reference design feature vector of a respective reference design in the set of reference designs; and
determining that the adjusted input design is absent a negative design feature.

14. The non-transitory computer-readable storage media of claim 8, wherein the ML model comprises a convolution neural network (CNN).

15. A system, comprising:
one or more processors; and
a computer-readable storage device coupled to the one or more processors and having instructions stored thereon which, when executed by the one or more processors, cause the one or more processors to perform operations for iteratively adjusting a data responsive to objective evaluation of the data using a machine learning (ML) model, the operations comprising:
receiving an input design recorded in a computer-readable file;
providing an input design feature vector representative of the input design by processing the input design through the ML model, the input design feature vector being extracted from the ML model at a layer preceding a final layer of the ML model;
determining a first sub-set of reference designs from a set of reference designs used to train the ML model, the first sub-set of reference designs being determined at least partially by calculating a first set of similarity scores, each similarity score indicating a degree of similarity between the input design feature vector and a reference design feature vector of a respective reference design in the first set of reference designs;
identifying at least a first design feature of a set of design features of the input design as a negative design feature at least partially by:
determining a set of statistics for each design feature in the set of design features based on label values of reference designs in the first sub-set of reference designs,
comparing a statistic of the at least a first design feature to a threshold, and
identifying the at least a first design feature as a negative design feature in response to the statistic failing to exceed the threshold;
in response to identifying the at least a first design feature vector as a negative design feature, selecting at least one reference design from the set of reference designs as a recommended design at least partially by:
determining a range for the at least a first design feature based on at least a portion of a set of statistics of the at least a first design feature, and
determining that a label value of the at least one reference design is within the range, and in response, selecting the at least one reference design from the set of reference designs as a recommended design; and
outputting a recommendation set comprising the recommended design for subsequent adjustment of the input design in view of the recommended design.

16. The system of claim 15, wherein operations further comprise identifying at least a second design feature of the set of design features of the input design as a positive design feature at least partially by:
comparing a statistic of the at least a second design feature to the threshold, and
identifying the at least a second design feature as a positive design feature in response to the statistic exceeding the threshold.

17. The system of claim 15, wherein the label value of the at least one reference design comprises an adjusted class label value that is adjusted from a class label value during tuning of the ML model to provide a tuned ML model.

18. The system of claim 17, wherein tuning of the ML model comprises retraining at least a portion of the ML model.

19. The system of claim 15, wherein the range is determined based on a Z-score of the at least a first design feature and a set of statistics of the at least a first design feature calculated from label values of the at least a first design feature over all reference designs in the set of reference designs.

20. The system of claim 15, wherein operations further comprise:
receiving an adjusted input design recorded in a computer-readable file, the adjusted input design comprising one or more modifications to the input design;
providing an adjusted input design feature vector representative of the adjusted input design by processing the adjusted input design through the ML model, the adjusted input design feature vector being extracted from the ML model at the layer preceding the final layer of the ML model;
determining a second sub-set of reference designs from the set of reference designs used to train the ML model, the second sub-set of reference designs being determined at least partially by calculating a second set of similarity scores, each similarity score indicating a degree of similarity between the adjusted input design feature vector and a reference design feature vector of a respective reference design in the set of reference designs; and
determining that the adjusted input design is absent a negative design feature.
